(19) United States
(12) Patent Application Publication
(10) Pub. No.: US 2012/0323359 A1
(43) Pub. Date: Dec. 20, 2012

(54) METHODS FOR ENHANCING VENDING MACHINE UTILIZATION AND DEVICES THEREOF

(75) Inventor: Jeffrey Richman, Webster, NY (US)

(73) Assignee: Mr. Jeffrey Charles Richman, Webster, NY (US)

(21) Appl. No.: 13/495,002

(22) Filed: Jun. 13, 2012

Related U.S. Application Data
(60) Provisional application No. 61/496,612, filed on Jun. 14, 2011.

(51) Int. Cl. G05D 3/00

(52) U.S. Cl. 700/232

(57) ABSTRACT

A method for vending one or more media products to a third party, comprising receiving a vending request for one or more products; reserving the movie at that kiosk for later pickup; generating a unique identifier for that reservation, upon a determination that the transaction data is approved; transmitting, to the customer and/or to a third party, the unique identifier for confirmation of the one or more reserved products; receiving a pickup request at the selected location for the reserved product including the unique identifier and possibly third party identification data; verifying the unique identifier; and vending the reserved product.

This patent application is a nonprovisional continuation of provisional application No. 61/496,612, filed on Jun. 14, 2011.

### FIELD

This invention relates to methods and devices that enhance vending machine utilization.

### BACKGROUND

Stand alone DVD and BD (Blu-ray Disc) dispensing machines are well known to provide movie and game rental at various locations, often 24 hours a day. DVD dispensing machines or rental kiosks currently allow visiting customers to select a movie, TV show, and/or game (subsequently referred to simply as “movies”), enter payment information or a promotional code, and retrieve the movie from the kiosk itself. Kiosk movie reservations can also be obtained by selecting, reserving, and entering payment information for a movie from a first location via the internet; and then traveling to a preselected machine, confirming reservation of the movie at the machine, and retrieving the movie from the kiosk to complete the transaction.

Though rental kiosk can be conveniently accessed 24 hrs a day, one problem with the current rental kiosk systems is the risk of danger to the customer in standing in front of an unmanned kiosk, particularly if the kiosk is located outside and/or the customer is utilizing it late at night. Furthermore, there is the unwanted inconvenience of simply traveling to the location of the desired rental kiosk and exposing the customer to hazardous driving conditions, normal risks, and inconveniences in travel, potentially inclement weather, etc. These same drawbacks are a major factor in the popularity of delivery services for, particularly, fast foods such as pizza or Chinese food.

While delivery service for fast food is common, personal delivery service of movies is unheard of. Modern digital streaming technologies allow, for a considerable fee, and drawing from a very limited media library, near-instant streaming of movies to a customer's television, but the drawbacks and expenses relegate this option to users with significant disposable income, high bandwidth internet connections, expensive TV's or internet-compatible media devices, and an interest in watching movies or TV shows that have been deemed no longer commercially viable. This limits the appeal of digital streaming

Other companies offer rental-by-mail services, wherein the customer can submit a rental request, then receive the disc containing that movie several days later, in the mail. The delay allows movie license holders better income for each movie, and thus the selection tends to be better. However, the delay of several days is a major drawback for customers.

Rental kiosks offer a compromise between the two extremes, allowing users to pay individually for each rental, thus benefitting license holders and allowing a better selection of movies than is available on digital streaming technologies, while allowing customers to pick the movies up nearly as quickly as they feel like doing so, avoiding the drawback of by-mail services.

However, while rental kiosk management technology permits consumers to reserve their rentals online prior to visiting the kiosk, there currently exists no way for a consumer to actually take delivery of their rented media without without having to personally travel to a kiosk. Specifically, there is no system in place, nor has there been any apparent reason to build one, which would allow a customer to communicate their reservation information to a third party for pickup. Currently, customers who have reserved rental media simply identify themselves at a kiosk by swiping their payment card, which a third party would not have access thereto.

### SUMMARY

A method for vending one or more media products to a third party, comprising receiving a vending request for the one or more products; wherein the vending request may include a location identifier, wherein the location identifier may comprise an address or zip code; determining the location of the requested product within a vendible product kiosk at a first pickup location based on inventory and proximity to the location identifier; receiving transaction data from the first computing device, wherein the transaction data comprises a first party name, billing address and payment information, and possibly delivery address; reserving the movie at that kiosk for later pickup; generating a unique identifier for that reservation, upon a determination that the transaction data is approved; transmitting, to the customer and/or to a third party, the unique identifier for confirmation of the one or more reserved products; receiving a pickup request at the selected location for the reserved product including the unique identifier and possibly third party identification data; transmitting a delivery data message, upon confirming that the third party identification data is valid; transmitting a vending signal to the kiosk at the first pickup location, wherein the signal instructs the kiosk to vend the reserved product to the third party; vending the reserved product at the first pickup location; and receiving an input signal that the transaction is complete.

The present invention enables a user to reserve a movie either separately or in combination with a second reserved item (or additional items) such as for example, an order of pizza, without the need of physically going to the vending machine. The present invention enables a non-renting third party to pick up the first party's reserved movie from a preselected machine, perhaps by entering the first party's reservation code via a touch-screen keyboard interface. This would allow, for instance, pizza delivery personnel to pick up a reserved movie for a customer and then deliver the movie to the customer along with an order of pizza. Thus, an individual is capable of purchasing and receiving a combination of separately ordered retail items without ever leaving the comforts of their own home, office, hotel, or any public or private building.

The present invention also enables delivery restaurants and companies to offer pickup service, requiring only the reservation identifier, which they can conceivably apply a surcharge for, or otherwise profit from by expanding their market to customers who would otherwise be driving to rental kiosks, and thus past non-delivery restaurants, in order to pick up their movie(s).

### BRIEF DESCRIPTION OF THE DRAWINGS

FIG. 1 is a block diagram of an environment with an exemplary vending management computing device.

### DETAILED DESCRIPTION

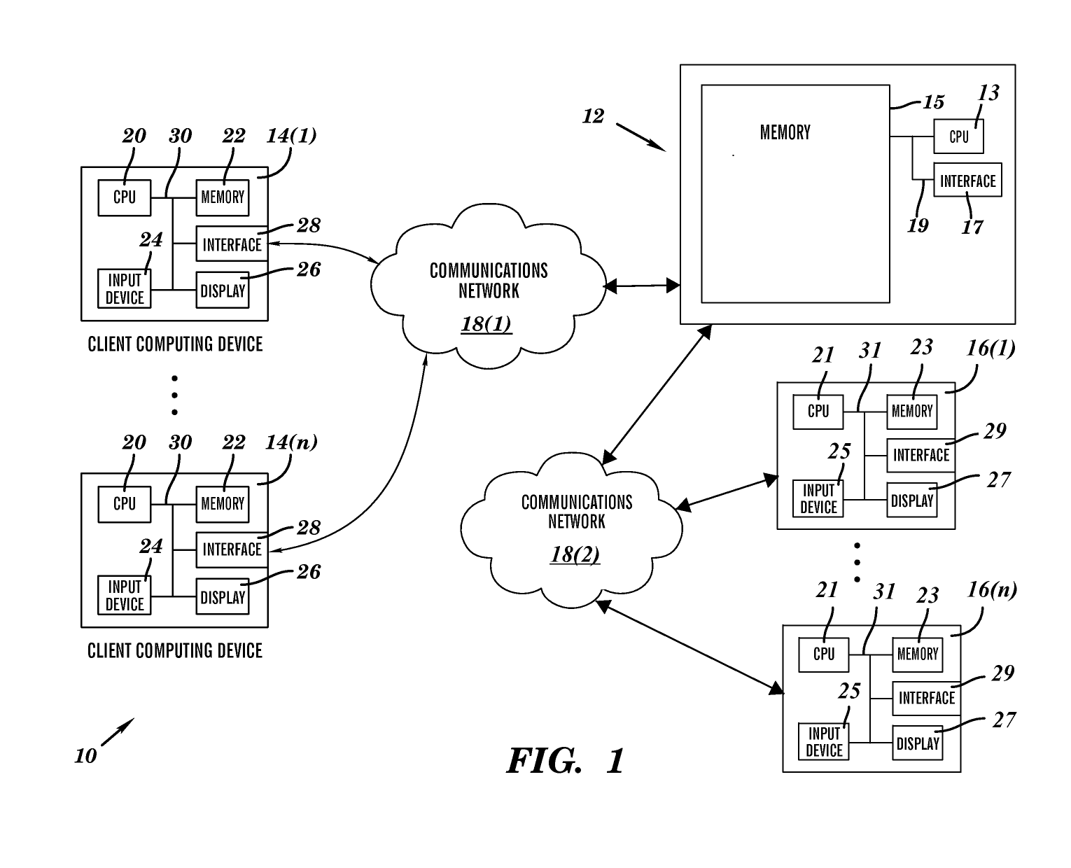

An exemplary environment 10 with a vending management computing device 12 configured to distribute one or more vendible product(s) to a non-paying third party is illustrated in FIG. 1. The exemplary environment 10 includes the vending management computing device or apparatus 12, client computing devices 14(1)-14(n), vendible product kiosk 16(1)-16(n), and communication networks 18(1)-18(2), although other numbers and types of systems, devices, and/or elements in other configurations and environments with other communication network topologies can be used. This technology provides a number of advantages including providing a more efficient, effective and automated method for a non-paying third party to retrieve a vendible product such as for example, a DVD movie and/or video games (or several) for a consumer, in order to then deliver the reserved movie(s) or game(s) to the customer, presumably along with some other delivered good.

Referring more specifically to FIG. 1, the vending management computing device 12 includes a central processing unit (CPU) or processor 13, a memory 15, and an interface system 17 which are coupled together by a bus 19 or other link, although other numbers and types of components, parts, devices, systems, and elements in other configurations and locations can be used. Additionally, other types and numbers of proxy servers or other computing devices could be configured to execute the exemplary methods illustrated and described herein. The processor 13 in the vending management computing device 12 executes a program of stored instructions one or more aspects of the present invention as described and illustrated by way of the embodiments herein, although the processor could execute other numbers and types of programmed instructions.

The memory 15 in the vending management computing device 12 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 13, can be used for the memory 15 in the vending management computing device 12.

The interface system 17 in the vending management computing device 12 is used to operatively couple and communicate between the vending management computing device 12 and the client computing devices 14(1)-14(n) and the vendible product kiosk 16(1)-16(n) via the communication networks 18(1) and 18(2), although other types and numbers of communication networks with other types and numbers of connections and configurations can be used. By way of example only, the communication networks 18(1) and 18(2) can use TCP/IP over Ethernet and industry-standard protocols, including HTTP, HTTPS, WAP, and SOAP, although other types and numbers of communication networks, such as a direct connection, a local area network, a wide area network, modems and phone lines, e-mail, and wireless and hardwire communication technology, each having their own communications protocols, can be used.

Each of the client computing devices 14(1)-14(n) enables a user to select, reserve, and pay for rental of a product from one or more web sites hosted by the vendible product kiosk 16(1)-16(n) through the vending management computing device 12 via one or more communication networks, although one or more of the client computing devices 14(1)-14(n) could access content and utilize other types and numbers of applications from other sources and could provide a wide variety of other functions for the user. Although multiple computing devices 14(1)-14(n) are shown, other numbers and types of user computing systems could be used. By way of example only, the computing device 14 could comprise a retail computing device located at a restaurant and accessed by a third party.

Each of client computing devices 14(1)-14(n) in this example is a computing device that includes a central processing unit (CPU) or processor 20, a memory 22, user input device 24, a display 26, and an interface system 28, and which are coupled together by a bus 30 or other link, although one or more of client computing devices 14(1)-14(n) can include other numbers and types of components, parts, devices, systems, and elements in other configurations. The processor 20 in each of client computing devices 14(1)-14(n) executes a program of stored instructions for one or more aspects of the present invention as described and illustrated herein, although the processor could execute other numbers and types of programmed instructions.

The memory 22 in each of the client computing devices 14(1)-14(n) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to processor 20 can be used for the memory 22 in each of the client computing devices 14(1)-14(n).

The user input device 24 in each of the client computing devices 14(1)-14(n) is used to input selections and other data, although the user input device could provide other functions and interact with other elements. The user input device can include keypads, touch screens, and/or vocal input processing systems although other types and numbers of user input devices can be used.

The display 26 in each of the client computing devices 14(1)-14(n) is used to show data and information to the user, such as a website page by way of example only. The display in each of the client computing devices 14(1)-14(n) is a computer screen display, although other types and numbers of displays could be used depending on the particular type of client device.

The interface system 28 in each of the client computing devices 14(1)-14(n) is used to operatively couple and communicate between the client computing devices 14(1)-14(n) and the vending management computing device 12 and vendible product kiosk 16(1)-16(n) over the communication networks 18(1) and 18(2), although other types and numbers of communication networks with other types and numbers of connections and configurations can be used.

The vendible product kiosk 16(1)-16(n) provide the distribution of one or more products from one or more web sites for use by one or more of the client computing devices 14(1)-14(n) via the vending management computing device 12, although the vendible product kiosk 16(1)-16(n) can provide other numbers and types of applications and/or content and can have provide other numbers and types of functions. Although vendible product kiosk 16(1)-16(n) are shown for ease of illustration and discussion, other numbers and types of product vending devices can be used.

Each of the vendible product kiosk 16(1)-16(n) include a central processing unit (CPU) or processor 21, a memory 23, and an interface system 29 which are coupled together by a bus 31 or other link, although each of the vendible product kiosk 16(1)-16(n) could have other numbers and types of components, parts, devices, systems, and elements in other configurations and locations can be used. The processor 21 in each of the vendible product kiosk 16(1)-16(n) executes a program of stored instructions one or more aspects of the present invention as described and illustrated by way of the embodiments herein, although the processor 21 could execute other numbers and types of programmed instructions.

The memory 23 in each of the vendible product kiosk 16(1)-16(n) stores these programmed instructions for one or more aspects of the present invention as described and illustrated by way of the embodiments, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in each of the vendible product kiosk 16(1)-16(n).

The interface system 29 in each of the vendible product kiosk 16(1)-16(n) is used to operatively couple and communicate between the vendible product kiosk 16(1)-16(n) and the vending management computing device 12 and the client computing devices 14(1)-14(n) via communication networks 18(1) and 18(2), although other types and numbers of communication networks with other types and numbers of connections and configurations can be used.

Although embodiments of the vending management computing device 12, the client devices 14(1)-14(n), and the vendible product kiosk 16(1)-16(n), are described and illustrated herein, each of the client computing devices 14(1)-14(n), the vending management computing device 12, and the vendible product kiosk 16(1)-16(n), can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any embodiment of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

The processor 13 in the vending management computing device 12 executes a program of stored instructions of one or more aspects of the method for distributing one or more products to a third party will now be described below.

Third Party “Online Rental Pick Up”

1. Visit an online movie rental website and select a movie of interest via client computing devices 14(1).

2. Enter your address and/or zip code on the website to find local kiosks with that movie in stock.

3. Select a kiosk location and, if desired, add additional movies to your cart.

4. Create an online customer account.

5. Enter credit/debit card information for billing.

6. Receive a reservation identifier of some sort. This may be an actual code of some kind, such as a randomly generated alphanumeric string, or it may be some combination of random data and/or personal data, such as your phone number and zip code.

7. Communicate that reservation identifier, either directly or via the first party, to a third party, such as to a pizza delivery restaurant.

8. The third party can send personnel, likely a delivery driver or other employee, to the selected vendible product kiosk 16(1), (it is assumed that restaurants will, in their advertising, indicate which kiosk or kiosks they offer pickup service for, to avoid long detours by delivery personnel).

9. That individual will utilize the vendible product kiosk 16(1) input device 25 to enter the reservation identifier, for instance, by selecting “ONLINE RENTAL PICK UP”, and then selecting “I HAVE A RESERVATION CODE” rather than swiping the payment card used by the first party to make the reservation.

10. That individual will then enter the reservation identifier, likely using an input interface device, such as, for example, a physical keyboard, a touch-screen keyboard interface, a virtual keyboard, a numeric keypad, a barcode scanner that reads a barcode printed out by the pizza shop on an order receipt, a Smartphone-integrated “bump” system, or the like.

11. That individual might be asked to swipe the magnetic strip on their driver's license, or to otherwise identify themselves or their employer, in order to maintain a legal record of who picked up the movie, in the event that it goes missing and they deny having picked it up. Most such kiosks, however, are monitored by security cameras, so this security step may be unnecessary. Alternatively, it may be integrated to a marketing campaign such that only restaurants or other companies with exclusive contracts can pick up reserved movies, perhaps paying a small fee for each such pickup.

12. That individual then receives the reserved movie(s) from a dispensing slot on the vendible product kiosk 16(1), at which point he or she can deliver the movies to either the end customer or to another intermediary such as a the restaurant's cashier (who might then hand over the movie to a final delivery driver, or to a customer who decided to pick up their order instead of waiting for delivery, or who might have some inability to travel to the kiosk themselves).

The method as described above enables the vendible product kiosk 16(1) via vending management computing device 12 itself to receive, from a non-paying third party, confirmation of the reservation, and to respond by validating that confirmation and then dispensing the end good to the third party, on the assumption that that third party will then deliver the good to the end customer.

As illustrated and described above with the examples herein, this technology provides a number of advantages including providing a more efficient, effective and automated method for the system in which the kiosk itself receives, from a third party, confirmation of the reservation, and to respond by validating that confirmation and then dispensing the end good to the third party, on the assumption that that third party will then deliver the good to the end customer. In other embodiments, a customer might call a delivery restaurant and have the restaurant make the reservation for them, using their credit card information. Alternatively, they might place their initial non-movie delivery order (say, for pizza) via the pizza restaurant's online ordering system, which is directly tied to the movie rental system, such that the customer can place an order for both at the same time, and in the same place, and the ordering system is responsible for communicating the reservation identifier to the pickup/delivery personnel. In another embodiment, the reservation might be made by another third party, such as a parent, for instance living in Cleveland, who rents a movie for their daughter attending college in Omaha, accepts all payment and billing obligations for that movie, and has it delivered to said daughter along with an order of, for instance, Chinese food.

In one embodiment, different reservation identifiers can be used. For example, the identifier may be a randomly generated alphanumeric string or a short alphanumeric string may be used, such as “DFS7SDF8”, numeric strings such as “238544”, non-encoded data if it does not represent an identity theft risk, or the like. Other types of alphanumeric strings and unique identifiers can be obtained and transmitted, such as combination of random data and personal data, such a telephone number and zip code by way of example only. As the reservation would likely be limited to a particular kiosk, and likely time limited, it seems that reservation identifiers can be reused nationally as the need arises, allowing for simpler identifier methods to be used.

In other embodiments, a customer can make a payment for movie rental by submitting credit/debit card information or financial information such as for example, credit/debit card information for billings, although other payment methods may be used such as for example, promotional codes and deals, an e-coupon, a gift card, direct bank account access or the like.

In a simple embodiment, a delivery restaurant takes an order by phone, receives during the order the reservation identifier, a delivery driver picks the reserved movie up using the identifier, and directly delivers it along with the rest of the order to the end customer. However, there may be additional personnel involved, such as a dedicated pickup driver who picks up the reserved movies and then brings them back to the restaurant for distribution among the delivery drivers. There might even be companies formed specifically to perform the pickup duty, delivering the movies either to the third party delivery restaurants or even directly to the end customer themselves, in the absence of a separate delivery order.

In other embodiments, the present invention enables an automat-style business, where food or other goods might be dispensed either directly to customers, or dispensed to authorized third parties such as restaurant employees, for delivery then to the customers. An order is processed entirely by machines, and the drive-through window employee simply enters your order number into the machine to receive the dispensed good, which they pass on to you.

In other embodiments, a customer might reserve a movie and give the reservation code by phone, email, or text to their son or daughter to pick up on their way home from some location. However, the son or daughter's plans change, so the end customers pick the movie up for themselves, possibly using the reservation identifier they received, rather than swiping a payment card. This might make sense if, for instance, their payment method is stored in their rental account, but they do not have immediate physical access to the card while at the kiosk, so they instead enter the reservation identifier that may have been emailed to their cell phone.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for enhancing vending machine utilization, the method comprising:
obtaining at a vending management computing device a product request for one or more of a plurality of vendible products at one of a plurality of remote vendible dispensing devices associated with a separate transaction for a good; and
providing with the vending management computing device a transaction identifier to the one of a plurality of remote vendible dispensing devices and to a computing device related to the separate transaction in response to the product request, the transaction identifier when entered at the one of a plurality of remote vendible dispensing devices releasing the one or more requested vendible products.

2. The method as set forth in claim 1 further comprising:
obtaining at the vending management computing device a location identifier associated with the separate transaction for the good;
providing with the vending management computing device an identification of one or more of the plurality of remote vendible dispensing devices within a first distance range of the retail computing device along with a list of the plurality of vendible products at the identified one or more of the plurality of remote vendible dispensing devices to a requesting computing device, the obtained request from the requesting computing device is based on the provided list.

3. The method as set forth in claim 1 further comprising completing at the vending management computing device a financial transaction for the one or more requested vendible products before the providing of the transactional identifier.

4. The method as set forth in claim 1 further comprising:
providing with the vending management computing device a transaction identifier by way of a computing device or data transfer technology to the requesting consumer and/or to another authorized recipient.

5. A computer readable medium having stored thereon instructions for enhancing vending machine utilization comprising machine executable code which when executed by at least one processor, causes the processor to perform steps comprising:
obtaining a product request for one or more of a plurality of vendible products at one of a plurality of remote vendible dispensing devices associated with a separate transaction for a good; and
providing a transaction identifier to the one of a plurality of remote vendible dispensing devices and to a computing device related to the separate transaction in response to the product request, the transaction identifier when entered at the one of a plurality of remote vendible dispensing devices releasing the one or more requested vendible products.

6. The method as set forth in claim 5 further comprising:
obtaining a location identifier associated with the separate transaction for the good;
providing an identification of one or more of the plurality of remote vendible dispensing devices within a first distance range of the retail computing device along with a list of the plurality of vendible products at the identified one or more of the plurality of remote vendible dispensing devices to a requesting computing device, the obtained request from the requesting computing device is based on the provided list.

7. The method as set forth in claim 5 further comprising completing a financial transaction for the one or more requested vendible products before the providing of the transactional identifier.

8. The method as set forth in claim 5 further comprising:
providing with the vending management computing device a transaction identifier by way of a computing device or data transfer technology to the requesting consumer and/or to another authorized recipient.

9. A vending management computing apparatus comprising:
one or more processors; and
a memory coupled to the one or more processors, the one or more processors configured to execute programmed instructions stored in the memory comprising:
obtaining a product request for one or more of a plurality of vendible products at one of a plurality of remote vendible dispensing devices associated with a separate transaction for a good; and
providing a transaction identifier to the one of a plurality of remote vendible dispensing devices and to a computing device related to the separate transaction in response to the product request, the transaction identifier when entered at the one of a plurality of remote vendible dispensing devices releasing the one or more requested vendible products.

10. The apparatus as set forth in claim 9 wherein the one or more processors is further configured to execute programmed instructions stored in the memory further comprising:
obtaining a location identifier associated with the separate transaction for the good;
providing an identification of one or more of the plurality of remote vendible dispensing devices within a first distance range of the retail computing device along with a list of the plurality of vendible products at the identified one or more of the plurality of remote vendible dispensing devices to a requesting computing device, the obtained request from the requesting computing device is based on the provided list.

11. The apparatus as set forth in claim 9 wherein the one or more processors is further configured to execute programmed instructions stored in the memory further comprising completing a financial transaction for the one or more requested vendible products before the providing of the transactional identifier.

12. The apparatus as set forth in claim 9 further comprising:
providing with the vending management computing device a transaction identifier by way of a computing device or data transfer technology to the requesting consumer and/or to another authorized recipient.
